(19) United States
(12) Patent Application Publication
(10) Pub. No.: US 2024/0342713 A1
(43) Pub. Date: Oct. 17, 2024

(54) FLUID CAPILLARY DEVICE

(71) Applicant: ACONDICIONAMIENTO TARRASENSE, Barcelona (ES)

(72) Inventors: Pooya AZIZIAN, Barcelona (ES); Adria ORTEGA NOVILLO, Barcelona (ES); Jordi RICART CAMPOS, Barcelona (ES); Joan Marc CABOT CANYELLES, Barcelona (ES); Jasmina CASALS TERRÉ, Barcelona (ES)

(21) Appl. No.: 18/699,092

(22) PCT Filed: Oct. 5, 2021
(86) PCT No.: PCT/ES2021/070720

§ 371 Date: Apr. 5, 2024

(51) Int. Cl. B01L 3/00

(52) U.S. Cl. CPC B01L 3/50273; B01L 3/502738; B01L 2200/12; B01L 2300/161; B01L 2400/0406; B01L 2400/0605

(57) ABSTRACT

The present invention relates to a device for controlling predetermined fluid sequences, which prevents unwanted diffusions between the same. The device is intended to control the flow of at least two fluids according to a preprogrammed path sequence, comprising a body (1) comprising a main reservoir (2), a main channel (3), at least one second reservoir (4) intended to house a second fluid, at least one secondary channel (5) connected to the second reservoir (4) and a liquid attraction element (6). Additionally, the body (1) comprises an air chamber (7) and at least one capillary check valve (8, 9), intended to retain the second fluid and at least two valve channels (10, 11) that enable the fluids to pass according to a predetermined sequence.

### OBJECT OF THE INVENTION

The present invention relates to a fluid capillary device, within the field of self-powered fluidic technology and with special application in assays in which small amounts of reagents, samples and solutions are used.

The device comprises a body equipped with channels and valves through which several fluids flow, due to which the predetermined sequences of the fluids are controlled by eliminating diffusion and uncontrolled mixing between solutions and/or reagents within a fluidic capillary process.

### BACKGROUND OF THE INVENTION

Various microfluidic capillary devices related to flow sequence control are known in the state of the art, such as, for example, the one disclosed in document U.S. Pat. No. 7,695,687B2, which is a capillary system for performing surface assays comprising a capillary pump containing at least two zones having different capillary pressures for obtaining a controlled flow rate of microfluids. The different pressure zones may be created by various means, such as by creating posts in the capillary pump, having different sized capillaries, changing wetting properties, defining friction, or by combinations of any of the above. The capillary system is used in various surface assays and can be programmed defining the volume and velocity of the microfluid flowing through the assay zones.

Likewise, WO2017066884A1 discloses a microfluidic device that includes a capillary circuit having a main channel and a sample reservoir that are fluidly connected and separated from each other by a sample release valve integrally formed with the capillary circuit.

However, in systems of this type there are usually diffusions between the preprogrammed sequences, altering the results of the assays, and additionally, the manufacture of said devices is usually very expensive.

### DESCRIPTION OF THE INVENTION

The present invention relates to a fluid capillary device, intended to control the flow of at least two fluids according to a preprogrammed path sequence, comprising a body, wherein the body comprises a main reservoir intended to house a first fluid, a main channel connected to the main reservoir, at least one second reservoir intended to house a second fluid, at least one secondary channel connected to the second reservoir and a liquid attraction element connected to the main channel that provides an external pressure generating a flow of the fluids through the channels by means of capillary action.

The body further comprises an air chamber, connected to the secondary channel, at least one capillary check valve, which is connected to the end of each secondary channel and faces the air chamber, wherein the capillary check valve is intended to retain the second fluid and at least two valve channels, which connect the air chamber and the main channel, in which the capillary pressure between the valve channels is different enabling the fluids to pass according to a predetermined sequence.

In this manner, the second liquid is released into the main channel in a controlled manner, preventing unwanted diffusion between fluids in preprogrammed fluid sequences. Due to the configuration of the check valve, the air chamber and the valve channels, the second fluid only passes through the air chamber once the first fluid has been evacuated from the main channel and in this manner the fluids do not mix in an unwanted way. Throughout the description, the term fluids refers to microfluids, millifluids and liquids.

The device is based on the passive capillary effect, which depends on the geometry and the properties of the surface to control the flow of fluids. Thus, the capillary check valve can be a protrusion that extends from the bottom of the secondary channel reducing the depth of the same such that it creates a type of valve that significantly reduces the curvature of the fluid meniscus and the capillary pressure is reduced to practically zero. Alternatively, the capillary check valve is an intermediate channel of smaller width than the secondary channel.

Capillary valve channels are formed as intersections of the main channel, wherein the fluid housed at these intersections is retained for a period of time until the release thereof is activated by another fluid in the main channel.

Valve channels are channels that are narrower than the main channel wherein they intersect with the main channel. The valve channels can be a first channel and a second channel for each second reservoir, in which the first channel is a channel with a greater depth than the second channel, such that the resistance it exhibits is lower and the liquid enters before in the first channel. The air chamber is a channel arranged transversely to the check valves wherein the channel can have a quadrangular, spherical, oval, curved shape, etc.

The body can comprise a reservoir between the liquid attraction element and the main channel, in which fluids can be mixed, a (bio)sensor can be incorporated, or a sample or solution can be incubated. The device is intended to control the sequence of a main fluid, which is usually the sample or activation solution of the system and at least one secondary fluid, which are the reagents or auxiliary solutions. Preferably there is a different secondary fluid for every second reservoir.

The liquid attraction element can be a capillary pump, a vacuum pump or an absorbent material such as absorbent paper, among others.

The air chamber or “chamber void” is a chamber that has air or any other gas such as dinitrogen, N2, inside.

The body may comprise a retention protrusion preferably housed in the main channel between the main reservoir and the valve channels.

Preferably the body is formed by a hydrophilic material such as polydimethylsiloxane (PDMS) that would be treated to be hydrophilic, obtained by means of a 3D printed mould or by any conventional manufacturing method such as soft lithography. The body can be printed directly with a 3D printer and adhesive can be used to seal the body and thus form the fluidic channels. Alternatively, the material of the body can be any other material as long as there is capillarity between the fluid and the body.

The project leading to this application has received funding from the European Union's “Horizon 2020” research and innovation programme under the Marie Sktodowska-Curie grant agreement No 813863.

### DESCRIPTION OF THE DRAWINGS

As a complement to the description provided herein, and for the purpose of helping to make the features of the invention more readily understandable, in accordance with a preferred practical exemplary embodiment thereof, said description is accompanied by a set of drawings constituting an integral part of the same, which by way of illustration and not limitation, represent the following:

FIG. 1 shows a first embodiment of a capillary device.

FIG. 2 shows a perspective view of a detail of a first configuration.

FIG. 3 is a sequence of images created by computational fluid dynamics showing the operation of the capillary valve.

FIG. 4 shows a second configuration of a device.

FIG. 5 shows a third configuration of a device.

### PREFERRED EMBODIMENT OF THE INVENTION

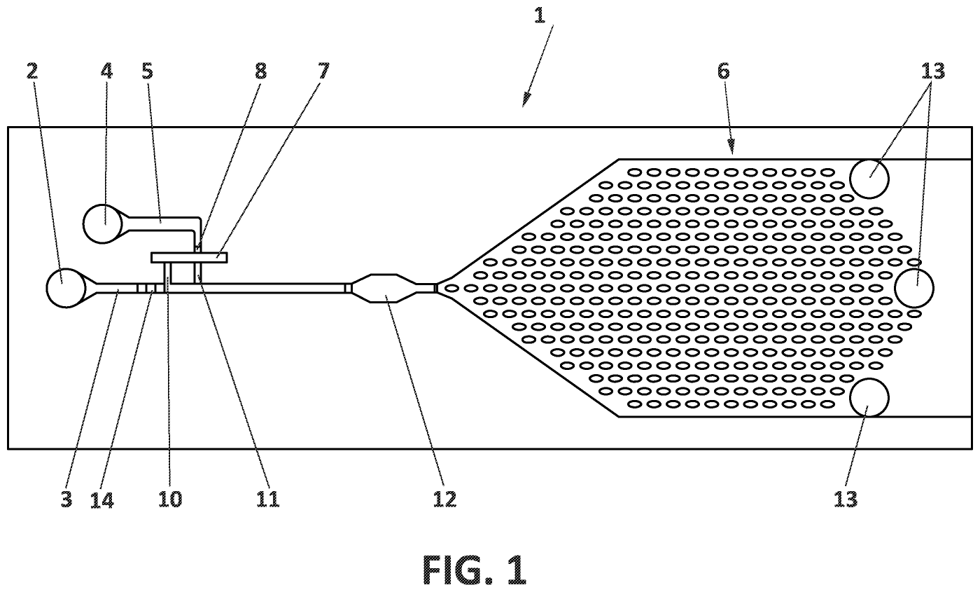

FIG. 1 shows a first embodiment of the capillary device, according to the present invention, wherein the capillary device for controlling the flow of fluids comprises a body (1) comprising a main reservoir (2) intended to house a first fluid and a main channel (3) connected to the main reservoir (2) and a second reservoir (4) intended to house a second fluid from which a secondary channel (5) extends.

The body (1) comprises a liquid attraction element (6) connected to the main channel (3) that provides an external pressure generating a flow of the fluids by means of capillary action, moving the fluids from the reservoirs (2, 4) thereof towards the liquid attraction element (6). The liquid attraction element (6) is of the structured repository type, which generates capillary pressure over a desired region without significant resistance.

The body comprises an air chamber, air chamber (7) connected to the secondary channel (5), and a capillary check valve (8, 9) which is a protrusion (8) at the end of the secondary channel (5) that faces the air chamber (7), wherein due to the protrusion (8) the curvature of the meniscus of the second fluid is significantly reduced and the capillary pressure is reduced practically to zero, such that the second fluid is retained just before reaching the air chamber (7).

The body (1) comprises at least two valve channels (10, 11), which are parallel in the embodiment shown and which connect the air chamber (7) and the main channel (3), wherein the capillary pressure of the valve channels (10, 11) is different from each other such that the sequence of fluids passing therethrough is controlled.

The body (1) comprises a reservoir (12) and the fluid attraction element (6) is a capillary pump comprising three air evacuation vents (13) that are openings within the fluid circuit connected to the air that enable the air to exit as the fluids fill the capillary pump.

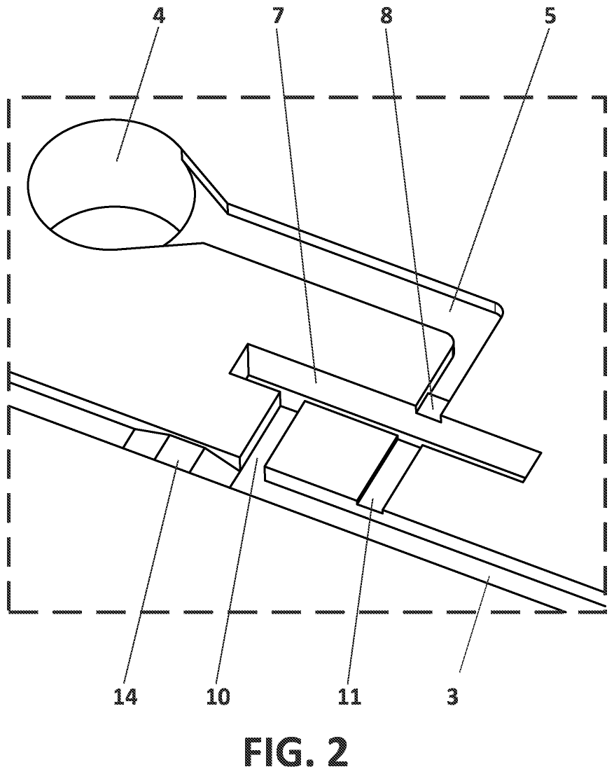

FIG. 2 shows a detailed perspective view of a first configuration, according to the present invention, in which the capillary check valve (8, 9) is a protrusion (8) that extends from the bottom of the secondary channel (5) reducing the depth of the same. The air chamber (7) is a quadrangular channel arranged transversely to the check valves (10, 11).

The valve channels (10, 11) intersect with the main channel (3). Specifically in the embodiment shown, the channels (10,11) extend perpendicular to the main channel (3) and are a first valve channel (10) and a second channel (11), wherein the first valve channel (10) has a greater depth than the second valve channel (11), the first valve channel (10) being closer to the main reservoir (2). The valve of greater depth, the first valve channel (10) offers lower resistance, such that the first fluid passes through it until it faces the air chamber (7) and subsequently enters the second valve channel (11).

The body (1) also has a retention protrusion (14) housed in the main channel (3) between the main reservoir (2) and the valve channels that retains the first fluid until the liquid attraction element (6) causes the fluid to overcome the resistance and enter the valve channels (10, 11). The retention protrusion (14) has a very high resistance to prevent air from entering the main reservoir (2). The protrusion may not be present in the hypothetical case that the section of the main channel (3) that goes from the main reservoir (2) to the valve channel (10) has a higher resistance than the valve.

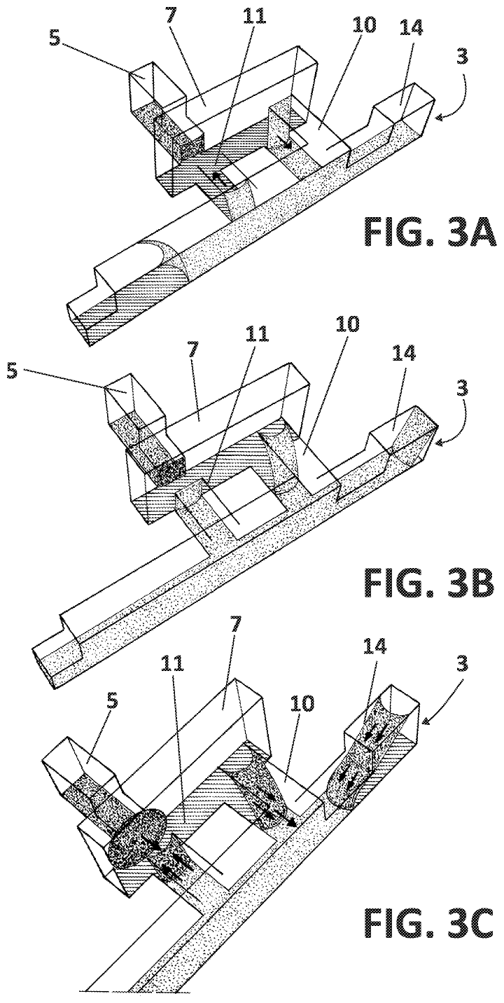

FIGS. 3A to 3C show a view of a sequence example, carried out in the device of the present invention, according to the first configuration, in which the second reservoir (4) is filled with a second fluid, and this is retained in the capillary retention protrusion (8) before the air chamber (7). The main reservoir (2) is then filled with the main fluid which, due to the pressure exerted by the liquid attraction element (6), moves in the direction of the first valve channel (10).

The main fluid enters the first valve channel (10), and then, upon reaching the second valve channel (11) which is shallower, the fluid advances in the second valve channel (11) pushing the fluid housed in the first channel (10), slightly towards the main channel (3), i.e., backwards.

Capillary action empties the main reservoir (2) and the depletion flow rate thereof stops in the main channel (3) upon reaching the retention protrusion (14). The air in the air chamber begins to evacuate through the first valve channel (10), which has lower resistance.

The suction of the liquid from the secondary channel (5) moves the air inside the air chamber (7) through the deepest channel, through the first channel (10), represented by arrows, causing the second fluid to go towards the air chamber (7). The second fluid is then led through the second valve channel (11) and flows into the main channel (3) joining the main fluid. Thus, due to the capillary action, the secondary fluid is emptied through the second valve channel (11) under the capillary action.

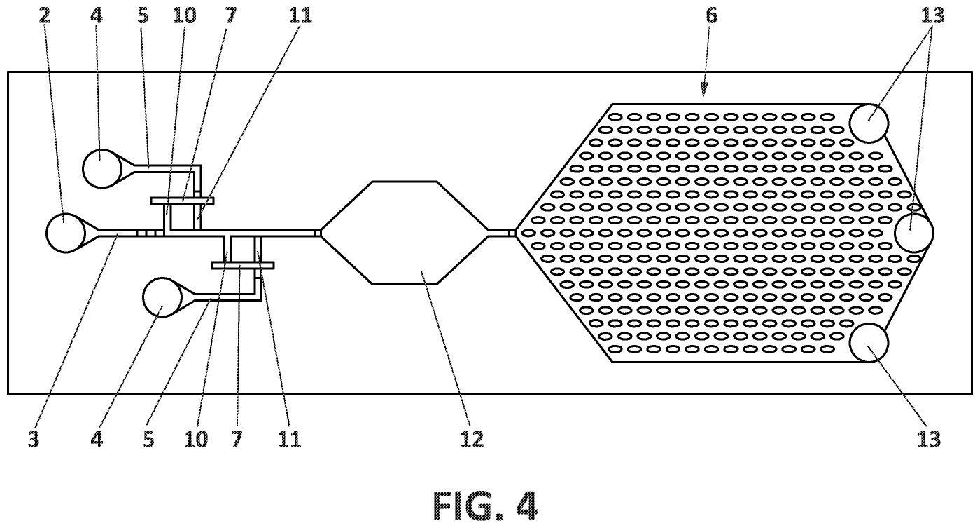

FIG. 4 shows a second configuration of the device, according to the present invention, wherein the body (1) has two second reservoirs (4) arranged on each side of the main channel (3), two secondary channels (5), two vacuum chambers (7) joined respectively to the secondary channels (5) and two channels for activating the valve channels (10, 11) joined to each air chamber (7).

In the case shown, the first valve channels (10), which are channels that exhibit a lower resistance than the second valve channels (11) as they are shallower, are the closest to the main reservoir (2). The capillary check valve (8, 9) is an intermediate channel (9) of smaller width than the secondary channel (5).

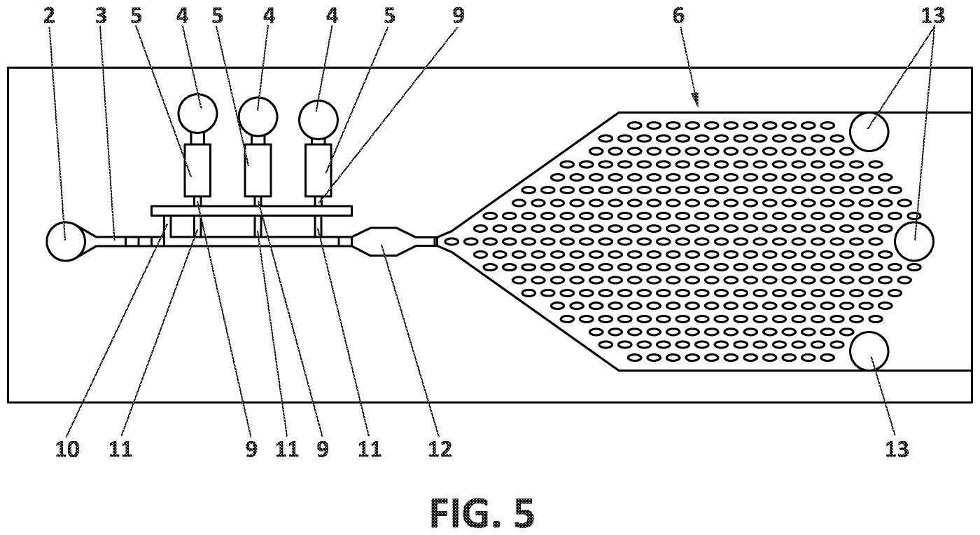

FIG. 5 shows a second configuration of the device, according to the present invention, wherein the body (1) comprises three second reservoirs (4) arranged on one side of the main channel (3), three secondary channels (5), an air chamber (7) joined to the secondary channels (5) and four valve channels (10, 11) connected to the air chamber (7), wherein the valve channels (10, 11) are a first valve channel (10) and three second valve channels (11) shallower than the first activation valve channel (10) and exhibiting different depths between them to achieve different resistances.

1. A fluid capillary device intended to control the flow of at least two fluids according to a preprogrammed path sequence, comprising a body (1) comprising:
a main reservoir (2) intended to house a first fluid;
a main channel (3) connected to the main reservoir (2);
at least one second reservoir (4) intended to house a second fluid;
at least one secondary channel (5) connected to the second reservoir (4);
a fluid liquid attraction element (6) connected to the main channel (3) that provides an external pressure generating a flow of the fluids through the channels (3, 5) by means of capillary action,
characterised in that the body (1) comprises:
an air chamber (7) connected to the secondary channel (5);
at least one capillary check valve (8, 9), which is connected to the end of each secondary channel (5) and faces the air chamber (7), wherein the capillary check valve (8, 9) is intended to retain the second fluid;
at least two valve channels (10, 11), connecting the air chamber (7) and the main channel (3), wherein the capillary pressure between the valve channels (10, 11) is different enabling the fluids to pass according to a predetermined sequence.

2. The device of claim 1, wherein the capillary check valve (8, 9) is a protrusion (8) that extends from the bottom of the secondary channel (5) reducing the depth of the same.

3. The device of claim 1, wherein the capillary check valve (8, 9) is an intermediate channel (9) of smaller width than the secondary channel (5).

4. The device of claim 1, wherein the valve channels (10, 11) are a first valve channel (10) and a second valve channel (11) for each second reservoir (4), wherein the first valve channel (10) has a larger cross section than the second valve channel (11).

5. The device of claim 4, wherein the first valve channel (10) has a greater depth than the second valve channel (11).

6. The device of claim 1, wherein the valve channels (10,11) are parallel to each other.

7. The device of claim 5, wherein the body (1) comprises a single second reservoir (4), a secondary channel (5), an air chamber (7) joined respectively to the secondary channel (5) and two valve channels (10, 11) joined to the air chamber (7).

8. The device of claim 5, wherein the body (1) comprises two second reservoirs (4) arranged on each side of the main channel (3), two secondary channels (5), two vacuum chambers (7) joined respectively to the secondary channels (5) and two valve channels (10, 11) joined to each air chamber (7).

9. The device of claim 1, wherein the body (1) comprises three second reservoirs (4) arranged on one side of the main channel (3), three secondary channels (5), an air chamber (7) joined to the secondary channels (5) and four valve channels (10, 11) joined to the air chamber (7).

10. The device of claim 1, wherein the body (1) comprises a reservoir (12) between the liquid attraction element (6) and the main channel (3).

11. The device of claim 1, wherein the fluid attraction element (6) is a capillary pump.

12. The device of claim 1, wherein the body (1) comprises a retention protrusion (14) housed in the main channel (3) between the main reservoir (2) and the valve channels (10, 11).

13. The device of claim 1, wherein the body (1) is formed by a hydrophilic material or at least a portion of the device.

14. The device of claim 1, wherein the body (1) is formed either by three-dimensional printing or polydimethylsiloxane (PDMS) from a mould made with three-dimensional printing.

15. The device of claim 1, wherein the air chamber (7) is a channel arranged transversely to the check valves (10, 11).
